(19) United States
(12) Patent Application Publication
(10) Pub. No.: US 2026/0192457 A1
(43) Pub. Date: Jul. 9, 2026

(54) METHOD AND DEVICE FOR HAND-EYE CALIBRATION USING MULTI-OPERATION

(71) Applicant: INDUSTRY-UNIVERSITY COOPERATION FOUNDATION HANYANG UNIVERSITY ERICA CAMPUS, Ansan-si, Gyeonggi-do (KR)

(72) Inventors: Tae-joon PARK, Seoul (KR); Senung-hoon SEO, Gunpo-si, Gyeonggi-do (KR); Jong-wan YOON, Ansan-si, Gyeonggi-do (KR); Byung-jin KO, Ansan-si, Gyeonggi-do (KR)

(21) Appl. No.: 19/130,534

(22) PCT Filed: Dec. 28, 2022
(86) PCT No.: PCT/KR2022/021473

§ 371 Date: Aug. 4, 2025

(30) Foreign Application Priority Data
Nov. 15, 2022 (KR) 10-2022-0153070

(51) Int. Cl. B25J 9/16

(52) U.S. Cl. CPC B25J 9/1692; B25J 9/163; B25J 9/1697

(57) ABSTRACT

Provided is a method and device for hand-eye calibration using multi-operation. The method for hand-eye calibration using multi-operation herein is implemented by a processor and comprises the steps of: receiving an input data set for a prescribed period from each of N (N is an integer of at least 2) motions of a robot arm; deriving N preprocessed data sets by preprocessing each of the N input data sets through a probability distribution conversion model; and outputting output data composed of translational values and rotational values from a vision-robot coordinate system conversion matrix generated using the N preprocessed data sets, wherein the step for outputting output data is repeated at least K (K is an integer greater than N) times to generate an output data set, and the output data set is post-processed through the probability distribution conversion model to output a single piece of post-processed data.

### TECHNICAL FIELD

The present invention relates to a method and device for hand-eye calibration using multi calculation, and more particularly, to a method and device for hand-eye calibration using multi calculation that may be applied to a vision-based arm-type industrial robot.

### BACKGROUND ART

An automatic hand-eye calibration system (automatic hand-eye calibration system; see FIG. 1) for calibration between an observer and a robot is applied to a vision-based arm-type industrial robot.

The automatic hand-eye calibration system redefines coordinate information extracted from image data acquired from a vision sensor based on the robot coordinate system. For example, an automatic hand-eye calibration system attaches a marker to an end effector of an arm-shaped robot, moves the robot into various postures, and then takes a picture of the marker with a vision camera. Thereafter, the automatic hand-eye calibration system utilizes the robot's positional information at the time the marker is captured, along with spatial information of the camera relative to the marker's coordinate system obtained through the marker, to formulate and solve a homogeneous transformation matrix equation between a base part of the robot and the vision camera, thereby automatically performing calibration work.

The existing method has limitations in terms of accuracy, and the reasons for this are as follows. In robotics, jittering is an uncontrolled, subtle shaking. As illustrated in FIG. 2, when power is applied to the robot, a base to end effector value of the robot has a subtle vibration value based on a specific value even if the robot is not operating. The jittering becomes an obstacle to obtaining camera parameters and robot parameters during a hand-eye calibration calculation, and affects the accuracy of the values.

Therefore, the existing automatic hand-eye calibration systems focus on modifying a hand-eye calibration equation or improving a robot's hardware control technology to provide a robust solution against jittering. However, the common feature of the existing automatic hand-eye calibration systems is that they use a single calculation method. The single calculation is on the premise that a method of obtaining data required for calibration uses a delta signal which is data at a specific moment. Therefore, when the single calculation method is used, the automatic hand-eye calibration systems are directly exposed to operating conditions with parameters heavily influenced by noise. For example, the calculation may be performed with data when the jittering is very severe. This significantly reduces the precision of the calibration value.

Due to the noise problem caused by the jittering, that is, the natural vibrations of the robot, the existing single calculation methods inevitably suffer from a decline in precision.

### DISCLOSURE

### Technical Problem

The present invention is directed to providing a method and device for hand-eye calibration using multi calculation capable of improving precision of result values through the multi calculation.

Meanwhile, other objects not specified in the present invention may be additionally considered within the scope that can be easily inferred from the following detailed description and effects thereof.

### Technical Solution

According to an aspect of the present invention, there is provided a method of hand-eye calibration implemented by a processor, including: receiving an input data set from each of N (N is an integer greater than or equal to 2) motions of a robot arm for a predetermined time; deriving N preprocessed data sets by performing preprocessing on each of the N input data sets through a probability distribution transformation model; and outputting data composed of a translation value and a rotation value from a vision-robot coordinate transformation matrix generated using the N preprocessed data sets, in which the outputting is repeatedly performed at least K times (K is an integer greater than N) to configure an output data set, and post-processing is performed on the output data set through the probability distribution transformation model to output a single piece of post-processed data.

The generated vision-robot coordinate transformation matrix may be modified using the single piece of post-processed data.

In the deriving, the probability distribution transformation model may include a process of arranging the input data set in order of size, dividing the input data set into certain intervals, calculating a binomial distribution of values corresponding to each interval, applying a normal approximation to transform the binomial distribution into the form of a normal distribution, and then removing a continuity constant.

In the outputting, the probability distribution transformation model includes a process of arranging the input data set in order of size, dividing the output data set into certain intervals, calculating a binomial distribution of values corresponding to each interval, applying a normal approximation to transform the binomial distribution into the form of a normal distribution, and then removing a continuity constant.

The probability distribution transformation model may include a normalization Softmax ensemble (NSE) technique.

N may be 3 and K may be 100.

There is provided a computer-readable recording medium storing one or more computer programs including instructions for performing the method of any one of the above paragraphs.

According to another aspect of the present invention, there is provided an device for hand-eye calibration, including: an input data set acquisition unit configured to acquire an input data set from each of N (N is an integer greater than or equal to 2) motions of a robot arm for a predetermined time; and a processor configured to perform preprocessing on each of the acquired N input data sets through a probability distribution transformation model to derive N preprocessed data sets, and output output data composed of a translation value and a rotation value from a vision-robot coordinate transformation matrix generated using the N preprocessed data sets, in which the processor repeatedly performs the process of outputting the output data at least K times (K is an integer greater than N) to configure an output data set, and performs post-processing on the output data set through the probability distribution transformation model to output a single piece of post-processed data.

### Advantageous Effects

The present technology provides a method and device for hand-eye calibration using multi calculation capable of improving precision of result values through the multi calculation.

### DESCRIPTION OF DRAWINGS

FIG. 1 is a diagram illustrating an automatic hand-eye calibration system;

FIG. 2 is a diagram illustrating jittering occurring in an automatic hand-eye calibration system as a graph;

FIG. 3 is a flowchart illustrating a method of hand-eye calibration according to an embodiment over time;

FIGS. 4A, 4B and 4C are diagrams illustrating the overall flow of a normalization Softmax ensemble (NSE) technique applied to the method of hand-eye calibration according to an embodiment;

FIG. 5 is a diagram illustrating the overall flow of an outputting operation according to an embodiment;

FIG. 6 is a graph illustrating the results of 100 experiments conducted to demonstrate the effectiveness of a data processing technique utilizing the NSE technique applied to the method of hand-eye calibration according to an embodiment;

FIG. 7 is a graph illustrating the performance evaluation of a data processing technique utilizing the NSE technique applied to the method of hand-eye calibration according to an embodiment;

FIG. 8 is a graph illustrating the results of a durability experiment by jittering intensity of the data processing technique utilizing the NSE technique applied to the method of hand-eye calibration according to an embodiment; and

FIG. 9 is a diagram illustrating an example of a hardware implementation of an device for hand-eye calibration according to an embodiment.

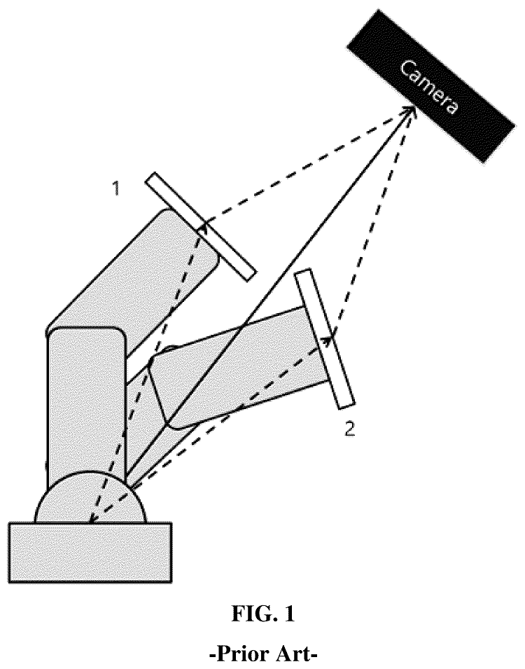

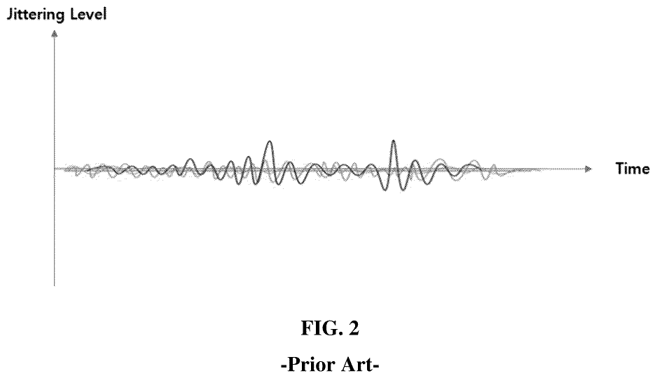

It is to be noted that the attached drawings are provided as references for understanding the technical idea of the present invention, and the scope of the rights of the present invention is not limited thereto.

### MODE FOR DISCLOSURE

Specific structural or functional descriptions of embodiments are disclosed for illustrative purposes only and may be modified and implemented in various forms. Therefore, the actual implemented form is not limited to the specific embodiments disclosed, and the scope of the present invention includes modifications, equivalents, or alternatives included in the technical idea described in the embodiments.

Although the terms “first,” “second,” etc., may be used to describe various components, such terms should be interpreted only for the purpose of distinguishing one component from another. For example, a first component may be named a second component and a second component may also be similarly named a first component.

It is to be understood that when any component is referred to as being connected to another component, it may be connected directly to or coupled directly to the other component or be connected to or coupled to the other component with another component intervening therebetween.

Singular expressions are intended to include plural expressions unless the context clearly indicates otherwise. It will be further understood that the terms “comprises” or “have” used in this specification specify the presence of stated features, steps, operations, components, parts, or a combination thereof, but do not preclude the presence or addition of one or more other features, numerals, steps, operations, components, parts, or a combination thereof.

Unless defined otherwise, all the terms used in the present specification, including technical and scientific terms, have the same meanings as meanings that are generally understood by those skilled in the art to which the present invention pertains. Terms generally used and defined in a dictionary are to be interpreted with the same meanings as meanings within the context of the related art, and are not to be interpreted with ideal or excessively formal meanings unless clearly indicated in the present specification.

Hereinafter, embodiments will be described in detail with reference to the accompanying drawings. In the description with reference to the accompanying drawings, the same components are given the same reference numerals throughout the drawings, and redundant descriptions thereof will be omitted.

Performing the process with parameters in a state where a natural vibration of a robot is severe in the hand-eye calibration process significantly reduces the accuracy of a calibration value. Therefore, in a hand-eye calibration process according to an embodiment, two processes, an input data preprocessing process using a normalization Softmax ensemble (NSE) model and a multi calculation process using an NSE technique, are applied.

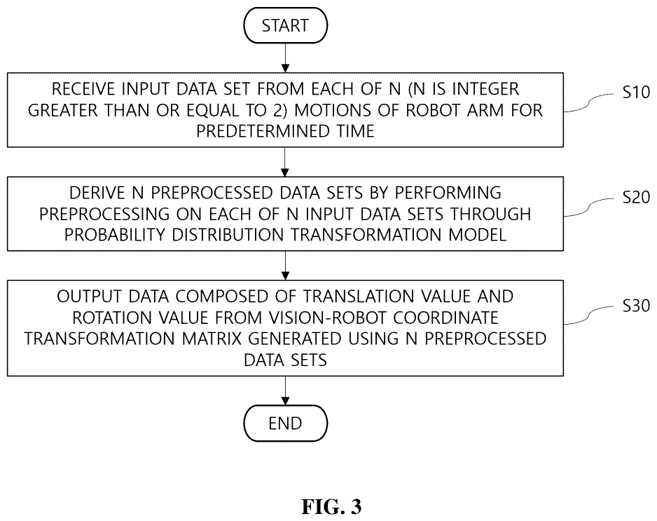

FIG. 3 illustrates a method of hand-eye calibration according to an embodiment over time. The method of hand-eye calibration includes an operation (S10) of receiving an input data set, an operation (S20) of deriving preprocessed data sets, and an operation (S30) of outputting output data.

In operation (S10), the device for hand-eye calibration receives an input data set from each of N motions of a robot arm for a predetermined time. Here, N may be an integer greater than or equal to 2, and preferably an integer greater than or equal to 3. Hereinafter, the description will be made based on an embodiment where N is 3, but the present invention is not limited to this number.

The predetermined time becomes the basis for the multi calculation. Instead of receiving a value at one moment, multiple data are input for a predetermined time, and preprocessing these data using the NSE technique becomes one means of eliminating jittering which is a natural vibration of a robot. The predetermined time may be, for example, 0.1 seconds to 1 second. The following description will focus on an example where the predetermined time is 0.1 seconds, but the present invention is not limited to this numerical value.

The input data set may be a matrix composed of translation values Tx, Ty, and Tz and rotation values Rx, Ry, and Rz. For example, there are matrices A, B, and X whose initial values are filled with elements of 0, and the predetermined time may continue until the required values for each matrix are satisfied. In this case, A may be a base to robot homogeneous transformation matrix. B may be an end effector to camera homogeneous transformation matrix. X may be a base to end effector homogeneous transformation matrix.

The input data set is received from each of the N motions, resulting in N input data sets. This is used to generate the vision-robot coordinate transformation matrix that will be described later.

In operation (S20), the device for hand-eye calibration performs preprocessing on each of the N input data sets through a probability distribution transformation model to derive N preprocessed data sets.

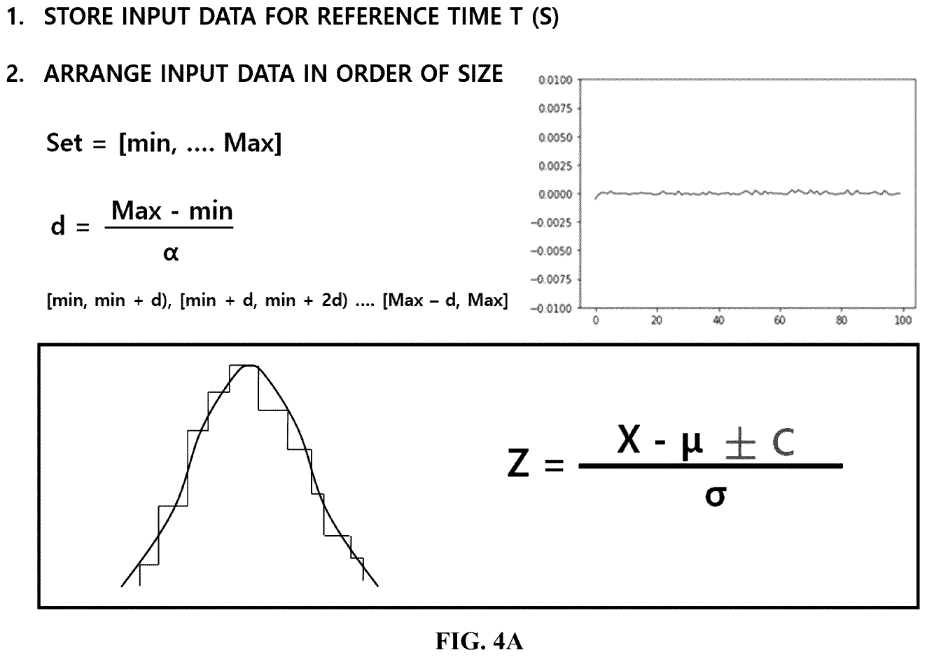

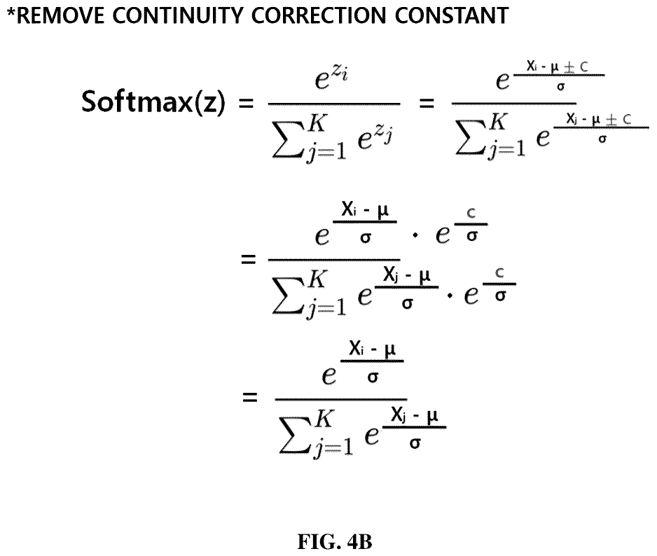

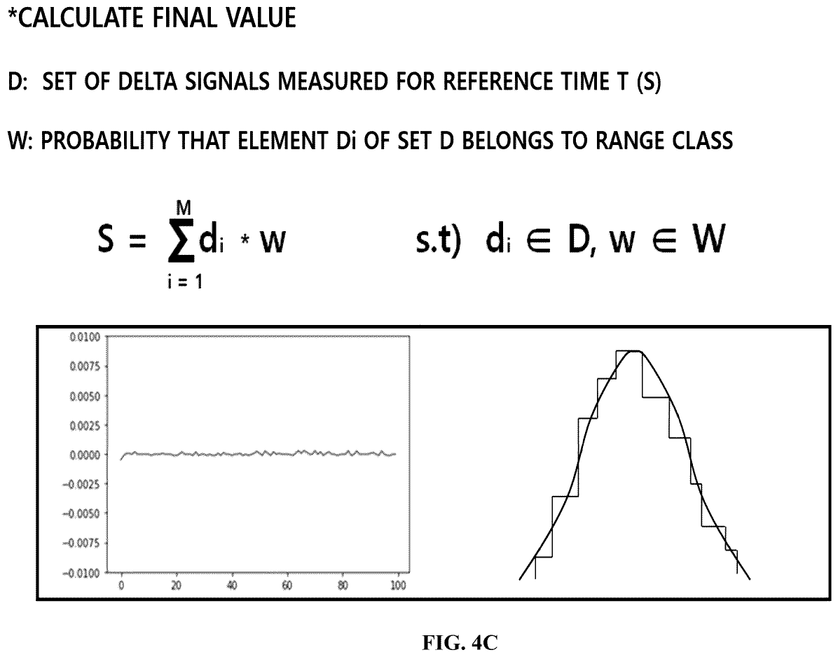

The probability distribution transformation model may use an NSE technique. The NSE technique according to an embodiment may include a process of calculating a binomial distribution, a process of transforming the binomial distribution to a normal distribution, and a process of removing a continuity constant. Specifically, as illustrated in FIGS. 4A to 4C, the NSE technique may include arranging the input data sets in order of size, dividing the input data sets into certain intervals, calculating a binomial distribution of values corresponding to each interval, applying a normal approximation to transform the binomial distribution into the form of a normal distribution, and then using Softmax to remove the continuity constant.

Then, since the number of elements in this array is the number of intervals and the total sum is 1, the preprocessed final value may be calculated by multiplying and adding the input data set received for the predetermined time with the elements of the array symmetrical to the corresponding interval. Then, the final value is input as an input parameter of the vision-robot coordinate transformation matrix (hand eye calibration matrix) to be described later.

For example, 100 data values received for 0.1 seconds may be sorted in order of size. This may be represented by the following Equation 1.

$$Set = [ min , … Max ] \qquad [ Equation 1 ]$$

$$d = \frac{Max - min}{α}$$

$$[ min , min + d ) , [ min + d , min + 2 d ) … [ Max - d , Max ]$$

Here, α is the number of classes. Thus, α classes are defined, and 100 result values are input as one element of the α classes. According to an embodiment, α may be defined as 10. Through this, data may be redefined as the binomial distribution representing the probability that an arbitrary result value exists within a specific interval. The data redefined as the binomial distribution may be subjected to a normal approximation again.

$$Z = \frac{X - μ \pm c}{σ} \qquad [ Equation 2 ]$$

In the above mathematical expression 2, ±C is a continuity correction constant for reducing the error between the binomial distribution and the normal distribution.

Meanwhile, in order to minimize the error between the binomial distribution and the normal distribution, the optimal constant C (0 to 1) value may be found. In this case, since the optimal constant C value is different for each distribution, the following Softmax function may be used to resolve this problem.

$$\begin{matrix}Softmax ( z ) = \frac{{e}^{{z}_{i}}}{{\sum }_{j = 1}^{K} {e}^{{z}_{j}}} = \frac{{e}^{\frac{{X}_{i} - μ \pm c}{σ}}}{{\sum }_{j = 1}^{K} {e}^{\frac{{X}_{j} - μ \pm c}{σ}}} \\ = \frac{{e}^{\frac{{X}_{i} - μ}{σ}} \cdot {e}^{\frac{c}{σ}}}{{\sum }_{j = 1}^{K} {e}^{\frac{{X}_{j} - μ}{σ}} \cdot {e}^{\frac{c}{σ}}} \\ = \frac{{e}^{\frac{{X}_{i} - μ}{σ}}}{{\sum }_{j = 1}^{K} {e}^{\frac{{X}_{j} - μ}{σ}}}\end{matrix} \qquad [ Equation 3 ]$$

The values obtained in this way may be stored in an array. When this array is W, W includes elements corresponding to the number of classes, and the total sum of these elements will be 1. Therefore, when the value of data received for 0.1 seconds is d, a data signal value used for hand-eye calibration may be defined as follows.

$$S = {{\sum }_{i = 1}}^{M} {d}_{i} * w s . t ) {d}_{i} ∈ D , w ∈ W \qquad [ Equation 4 ]$$

In other words, the data signal value may be seen as a result reflecting the probability that one delta value * corresponding value appears. Here, the w value is the probability value that the class to which di corresponds has.

In operation (S30), the device for hand-eye calibration generates a vision-robot coordinate transformation matrix using N preprocessed data sets, and outputs the output data composed of the translation values and the rotation values from the vision-robot coordinate transformation matrix.

Note that the data used to generate the vision-robot coordinate transformation matrix is data preprocessed using the NSE technique described above.

In order to generate the vision-robot coordinate transformation matrix (hereinafter also simply referred to as the “transformation matrix”), for example, an equation composed of matrices A, B, and X should be solved. To this end, various solutions may be applied, but as an example, it is assumed that an equation such as Aj*inv(Ai)*X=X*Bj*inv*(Bi) is solved.

The output data may be a matrix composed of translation values Tx, Ty, and Tz and rotation values Rx, Ry, and Rz.

Meanwhile, the device for hand-eye calibration repeatedly performs operation (S30) at least K times to configure the output data set, and performs the post-processing on the output data set through the probability distribution transformation model (i.e., NSE technique) to output the single piece of post-processed data. As a result, the vision-robot coordinate transformation matrix is modified using the single piece of post-processed data.

K may be an integer greater than N, and preferably an integer greater than or equal to 100. Hereinafter, the description will be made based on an embodiment where N is 100, but the present invention is not limited to this number.

The above-described N is for generating the transformation matrix, and when only the transformation matrix may be generated, a smaller N is preferable for calculation efficiency, while K is another basis for multi calculation, and a larger K is preferable for the resolution of the jittering, but it is also preferable to consider the efficiency of the operation as well.

It is to be noted that the above-described operation (S20) is performed on the input data set configured by being received for a predetermined time, and operation (S30) is performed on the output data set configured by repeatedly performing operation (S30). That is, in the former, the size of the data set is determined by the predetermined time, and in the latter, the size of the data set is determined by the number of repetitions. This makes it possible to apply two processes, the input data preprocessing process using the NSE technique and the multi calculation process using the NSE technique, to resolve the jittering.

The NSE technique in operation (S30) is generally similar to the NSE technique in the above-described operation (S20). That is, in operation (S30), the NSE technique includes the process of calculating the binomial distribution, transforming the binomial distribution to the normal distribution, and removing the continuity constant. Specifically, the NSE technique may include arranging the data sets in order of size, dividing the data sets into certain intervals, calculating the binomial distribution of the values corresponding to each interval, applying the normal approximation to transform the binomial distribution into the form of the normal distribution, and then using the Softmax to remove the continuity constant.

Then, since the number of elements in this array corresponds to the number of intervals and the total sum is 1, the post-processed single final value may be calculated by multiplying and adding the output data set output for the repeated execution process with the elements of the array symmetrical to the corresponding interval. This final value is used to modify the vision-robot coordinate transformation matrix.

For example, the vision-robot coordinate transformation matrix may be generated using N preprocessed data sets, and Tx, Ty, Tz, Rx, Ry, Rz values may be extracted from the generated transformation matrix, and then stored in Txset, Tyset, Tzset, Rxset, Ryset, and Rzset, respectively. When this process is performed 100 times, 100 calculated values may be stored in each set. The calculated values are continuous random variables, may have values between −∞ and ∞, and have a probability close to 0, but when the hand eye calibration is performed normally, such calculated values will be concentrated around a specific value within a certain range. In this way, the NSE technique in the above-described operation (S20) may be applied to all of the data calculated 100 times, Tx, Ty, Tz, Rx, Ry, and Rz, and then the transformation matrix may be modified.

As a result, the modified vision-robot coordinate transformation matrix composed of the single piece of post-processed final value is generated. The modified vision-robot coordinate transformation matrix is used to redefine the coordinate information extracted from the image data acquired by the vision sensor based on the robot coordinate system. In other words, the modified vision-robot coordinate transformation matrix is used to control the end effector of the robot.

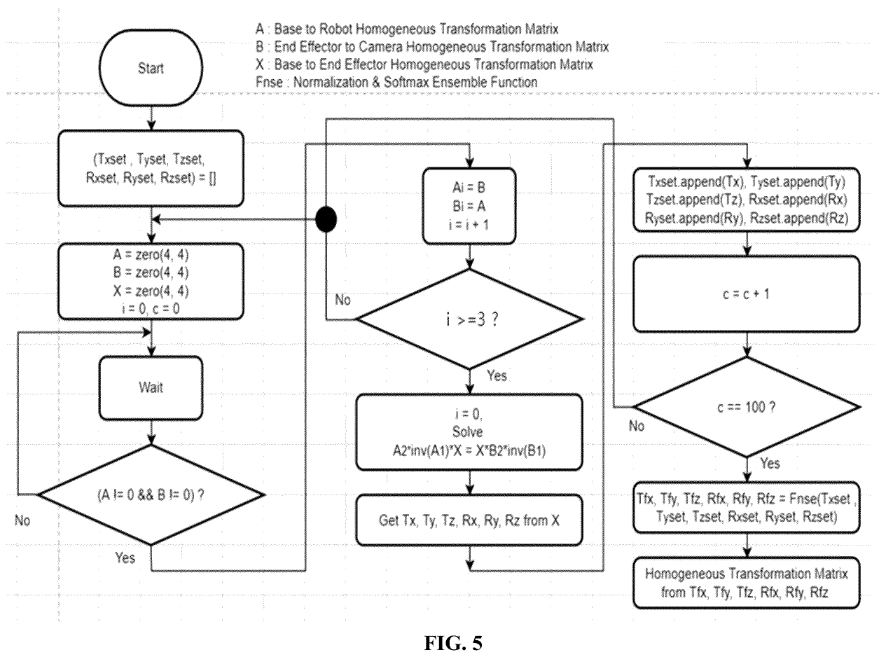

FIG. 5 illustrates the overall flow of the above-described operation (S30). As illustrated in FIG. 5, it includes waiting until the matrix value required for the hand-eye calibration is satisfied. The initial value is a matrix filled with elements of 0.

In order to form the hand eye calibration matrix equation, data is received from at least 3 motions (i≥3?). In this case, the input data is data preprocessed by the NSE technique.

The hand eye calibration matrix equation (i=0, Solve A2*inv(A1)*X=X*B2*inv*(B1)) is solved, and the translation values Tx, Ty, and Tz and the rotation values Rx, Ry, and Rz are obtained from the matrix (X) obtained as the result value (Get Tx, Ty, Tz, Rx, Ry, Rz from X).

This is repeated 100 times (c==100?).

The translation values Tx, Ty, and Tz and the rotation values Rx, Ry, and Rz obtained by performing 100 calculations are synthesized into a single final value using the NSE technique (Tfx, Tfy, Tfz, Rfx, Rfy, Rfz=Fnse (Txset, Tyset, Tzset, Rxset, Ryset, and Rzset)) (homogeneous transformation matrix from Tfx, Tfy, Tfz, Rfx, Rfy, and Rfz).

### EXPERIMENTAL EXAMPLE

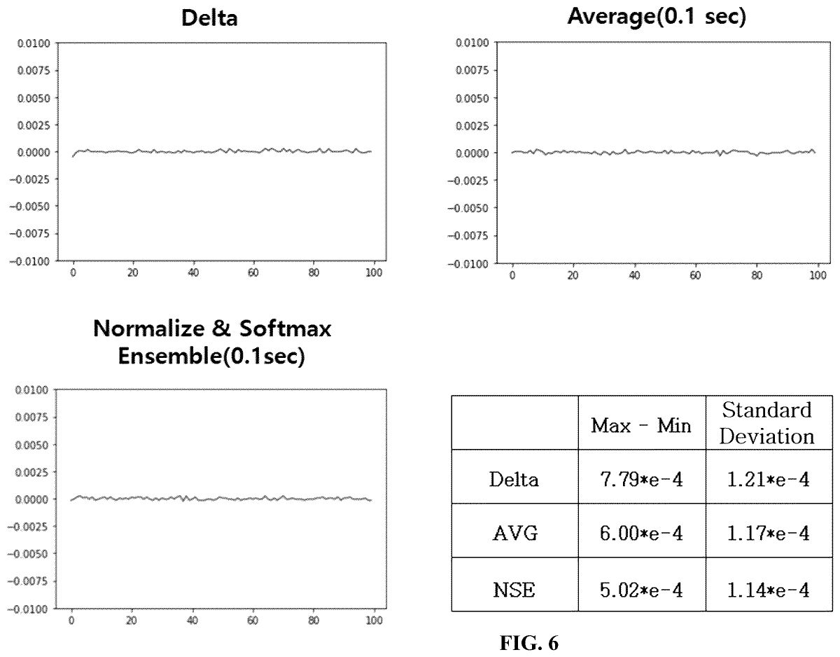

FIG. 6 illustrates the results of 100 experiments conducted to demonstrate the effectiveness of a data processing technique utilizing the NSE technique applied to the method of hand-eye calibration according to an embodiment.

As illustrated in FIG. 6, graphs of a delta value (delta) of an input signal, the result (average (0.1 sec)) when processing an average (AVG) of approximately 200,000 input signals received for 0.1 seconds, and when processing with the NSE technique (Normalize & Softmax Ensemble (0.1 sec)) are each illustrated. In addition, in order to determine the degree of dispersion of the values, the average is made 0, and the difference between the maximum and minimum values and the standard deviation when using each technique are calculated and shown in a table.

The AVG method uses a method of averaging approximately 200,000 data received for 0.1 seconds, and is a method designed to resolve cases where values are obtained as outliers. Based on the AVG method, the NSE method is a method of applying a probabilistic model to further improve performance, and multiplying weights based on the probability of each piece of data received for 0.1 seconds occurring. Since the NSE method is a method of obtaining a final value by assigning higher influence to signals closer to the average of the data received for 0.1 seconds and lower influence to signals farther from the average, when 100 experiments were performed, compared to the Delta method and the AVG method, it showed a smaller difference between the maximum and minimum values and a lower standard deviation. This illustrates that the NSE method may reduce the influence of the jittering and contribute to obtaining camera parameters and robot parameters required to calculate the stable hand-eye calibration.

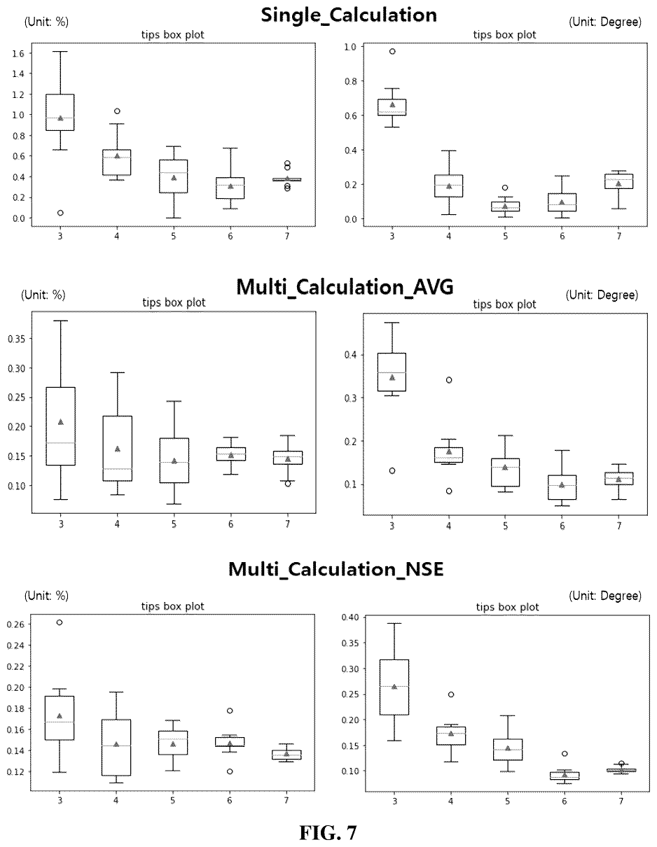

FIG. 7 illustrates the performance evaluation of a data processing technique utilizing the NSE technique applied to the method of hand-eye calibration according to an embodiment.

To evaluate the performance of the translation component, the Euclidean distance between the camera coordinate system and the base coordinate system of the robot is used as the denominator and the Euclidean distance between the measured translation values Tx, Ty, and Tz and the estimated translation values Tx′, Ty′, and Tz′ is used as the numerator, and the result was expressed as a percentage.

Meanwhile, the angle values may not be expressed using the Euclidean distance method as with the translation values. In some cases, a method (for example, a method of evaluating the overall angular error performance by taking the measured value as the denominator for the angular values (Rx, Ry, Rz) and the error between the measured value and the estimated value as the numerator, and averaging the percentages of each element of the angular value) similar to the above method may result in no change in the angle values between two coordinate systems, leading to elements with a measured value of zero. When these elements are expressed as a percentage, the result may also have an infinite value. Therefore, a method of simply calculating the difference between the measured angle values Rx, Ry, and Rz and the estimated angle values Rx′, Ry′, and Rz′ to obtain the average difference value was used.

Similar to FIG. 6 described above, a comparative analysis was conducted on models using the single calculation method, the method of performing 100 calculations and calculating an average for each result, and the NSE method for performing 100 calculations and calculating an average for each result. The three models commonly used NSE data processing techniques to acquire and compute the data required for the hand-eye calibration calculation.

In addition, for a fair performance evaluation experiment, a method of randomly selecting n out of 100 datasets acquired using the NSE data processing technique and calculating the selected datasets was used. This experiment was performed 100 times for each of (n=3, 4, 5, 6, 7) and expressed in a graph. The more images are used in the calculation, the more precise the camera calibration value may be estimated, and therefore the accuracy of the model tends to increase gradually. However, since the experiment was conducted by randomly selecting data, it is not absolutely shown in the graph. A table related to the performance of each model is shown below. The table below illustrates the mean error and mean standard error for the translation and rotation. The mean error is related to the model's accuracy, the mean standard error is related to the model's stability, and lower values for both the mean error and the mean standard error are better.

TABLE 1

| | |
|---|---|
| Error Mean | Standard Error of Mean |

Single_Calculation

| | | |
|---|---|---|
| Translation | 0.5623 | 0.0365 |
| Rotation | 0.2785 | 0.0374 |

Multi_Calculation_AVG

| | | |
|---|---|---|
| Translation | 0.1731 | 0.0146 |
| Rotation | 0.1826 | 0.0095 |

Multi_Calculation_NSE

| | | |
|---|---|---|
| Translation | 0.1546 | 0.0142 |
| Rotation | 0.1644 | 0.0093 |

As illustrated in Table 1, compared to the single calculation method model, the average translation error was reduced to 0.4077%, the average rotation error was reduced to 0.1141%, the average translation standard error was reduced to 0.0223, and the average rotation standard error was reduced to 0.0281.

Compared to the degree of improvement of the multi calculation AVG method described in FIG. 6 over the delta method, the improvement of the multi calculation AVG model over the single calculation model illustrated in FIG. 7 is clearly evident. In particular, as illustrated in the graph in FIG. 7, the difference is more noticeable when a small number of images are used for calculation. This is because when a small number of images are used for calculation, the precision of the intrinsic parameter of the camera decreases, which in turn affects the extrinsic parameter of the camera, and the matrix values corresponding to the camera parameter are all different.

As the number of images increases, the camera calibration technique causes the camera parameter to have relatively precise values, and the improvement tends to decrease, which illustrates that it is still valid. The Multi_Calculation_NSE model is a model designed to improve performance by applying a probabilistic model to each calculation result value based on the Multi_Calculation_AVG model.

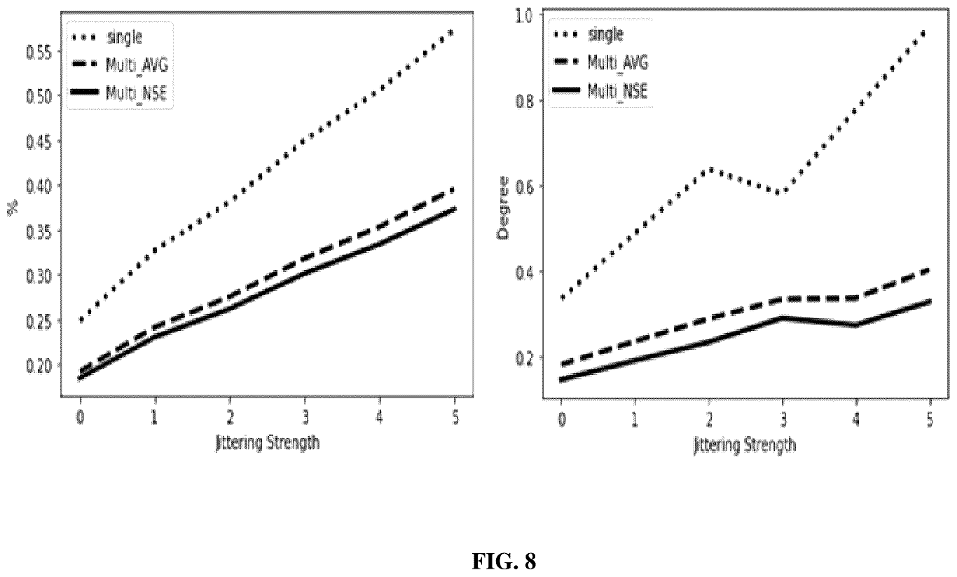

FIG. 8 is the results of a durability experiment by jittering intensity of the data processing technique utilizing the NSE technique applied to the method of hand-eye calibration according to an embodiment. The graph illustrates the average error of the Euclidean distance and the average error of the degree at each jittering intensity after performing 100 experiments with data extracted from 7 positions according to jitter intensity by intentionally causing the jittering.

As illustrated in the drawings, it may be seen that the single method is greatly affected by abnormal data occurring with the jittering, and it may be confirmed that the multi AVG and multi NSE methods are more robust to the jittering than the single method. It was confirmed that the multi NSE method based on the probability is more robust than the method of calculating an average of all operation results.

In this way, according to an embodiment, the data preprocessing technique using the NSE method and the multi calculation system method based on the probabilistic model may reduce the influence of the jittering and the result value deviation occurring between datasets in the auto hand eye calibration system, thereby providing more robust and stable result values.

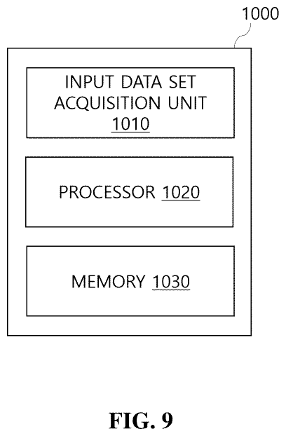

FIG. 9 is a diagram illustrating an example of a hardware implementation of an device for hand-eye calibration according to an embodiment. The device 1000 for hand-eye calibration according to an embodiment may include an input data set acquisition unit 1010, a processor 1020, and a memory 1030.

The input data set acquisition unit 1010 may acquire an input data set from each of N (N is an integer greater than or equal to 2) motions of a robot arm for a predetermined time. The input data set acquisition unit 1010 may include a communication unit, etc., that is connected to a vision camera and receives an input data set.

The processor 1020 may perform the preprocessing on each of the N input data sets acquired above using the probability distribution transformation model (i.e., NSE technique) stored in the memory 1030 to derive N preprocessed data sets, and output output data composed of the translation values and the rotation values from the vision-robot coordinate transformation matrix generated using the N preprocessed data sets. In this case, the process may be repeatedly performed at least K times (K is an integer greater than N) to configure the output data set, and the post-processing may be performed on the output data set through the probability distribution transformation model to output the single piece of post-processed data. The generated vision-robot coordinate transformation matrix may be modified using the single piece of post-processed data. However, the operation of the processor 1020 is not limited thereto, and the operations described in FIGS. 3 to 8 may be performed.

The memory 1030 may store the probability distribution transformation model (i.e., NSE technique). The memory 1030 may temporarily or permanently store data required to perform a method of hand-eye calibration according to an embodiment. For example, the memory 1030 may store input data set(s), preprocessed data set(s), a vision-robot coordinate transformation matrix, an output data set, a modified vision-robot coordinate transformation matrix, etc.

The device 1000 according to an embodiment receives input data required for a hand-eye calibration process for a predetermined time and then preprocesses the received input data using the NSE technique. In addition, the device applies a multi calculation process to the output data obtained from the transformation matrix by post-processing the output data using the NSE technique. This improves the hand-eye calibration accuracy due to the jittering.

The embodiments described above may be implemented by hardware components, software components, and/or combinations of hardware components and software components. For example, the devices, the methods, and the components described in the embodiments may be implemented using a general purpose computer or a special purpose computer such as a processor, a controller, an arithmetic logic unit (ALU), a digital signal processor, a microcomputer, a field programmable gate array (FPGA), a programmable logic unit (PLU), a microprocessor, or any other devices that may execute instructions and respond to the instructions. A processing device may execute an operating system (OS) and software applications executed on the operating system. In addition, the processing device may access, store, manipulate, process, and create data in response to execution of software. Although a case in which one processing device is used is described for convenience of understanding, it may be recognized by those skilled in the art that the process device may include a plurality of processing elements and/or plural types of processing elements. For example, the processing device may include a plurality of processors or one processor and one controller. In addition, other processing configurations such as parallel processors are also possible.

The software may include computer programs, codes, instructions, or a combination of one or more thereof, and may configure the processing device to be operated as desired or independently or collectively command the processing device to be operated as desired. The software and/or the data may be permanently or temporarily embodied in any type of machine, component, physical device, virtual equipment, computer storage medium or device, or transmitted signal wave to be interpreted by the processing device or provide instructions or data to the processing device. The software may be distributed on computer systems connected to each other by a network to be thus stored or executed by a distributed method. The software and the data may be stored in computer-readable recording media.

The methods according to the embodiment may be implemented in the form of program commands that may be executed through various computer means and may be recorded in a computer-readable recording medium. The computer-readable medium may store program commands, data files, data structures, etc., alone or in combination, and the program commands recorded on the medium may be those specially designed and configured for the embodiments or may be known and available to those skilled in the art of computer software. Examples of the computer-readable recording medium may include a magnetic medium such as a hard disk, a floppy disk, or a magnetic tape; an optical medium such as a compact disc read only memory (CD-ROM) or a digital versatile disc (DVD); a magneto-optical medium such as a floptical disk; and a hardware device specially configured to store and execute program commands, such as a ROM, a RAM, a flash memory, or the like. Examples of the program commands may include machine language codes such as those made by compilers as well as high-level language codes capable of being executed by computers using interpreters, or the like.

The above-described hardware device may be constituted to be operated as one or more software modules to perform the operations of the embodiments, and vice versa.

Although the embodiments have been described above with reference to the limited drawings, various modifications and alternations are possible by those of ordinary skill in the art from the above description. For example, even if the described techniques are performed in a different order than the described method, and/or components of the described systems, structures, devices, circuits, etc., are combined in a different manner than the described method, or replaced or substituted by other components, appropriate results may be achieved.

Therefore, other implementations, other embodiments, and equivalents of the claims are within the scope of the following claims.

### DESCRIPTION OF REFERENCE NUMERALS

1000: Device for hand-eye calibration
1010: Input data set acquisition unit
1020: Processor
1030: Memory

1. A method of hand-eye calibration implemented by a processor, comprising:
receiving an input data set from each of N (N is an integer greater than or equal to 2) motions of a robot arm for a predetermined time;
deriving N preprocessed data sets by performing preprocessing on each of the N input data sets through a probability distribution transformation model; and
outputting data composed of a translation value and a rotation value from a vision-robot coordinate transformation matrix generated using the N preprocessed data sets,
wherein the outputting is repeatedly performed at least K times (K is an integer greater than N) to configure an output data set, and post-processing is performed on the output data set through the probability distribution transformation model to output a single piece of post-processed data.

2. The method of claim 1, wherein the generated vision-robot coordinate transformation matrix is modified using the single piece of post-processed data.

3. The method of claim 1, wherein, in the deriving, the probability distribution transformation model includes a process of arranging the input data set in order of size, dividing the input data set into certain intervals, calculating a binomial distribution of values corresponding to each interval, applying a normal approximation to transform the binomial distribution into the form of a normal distribution, and then removing a continuity constant.

4. The method of claim 1, wherein, in the outputting, the probability distribution transformation model includes a process of arranging the input data set in order of size, dividing the output data set into certain intervals, calculating a binomial distribution of values corresponding to each interval, applying a normal approximation to transform the binomial distribution into the form of a normal distribution, and then removing a continuity constant.

5. The method of claim 1, wherein the probability distribution transformation model includes a normalization Softmax ensemble (NSE) technique.

6. The method of claim 1, wherein N is 3 and K is 100.

7. A computer-readable recording medium storing one or more computer programs including instructions for performing the method of claim 1.

8. An device for hand-eye calibration, comprising:
an input data set acquisition unit configured to acquire an input data set from each of N (N is an integer greater than or equal to 2) motions of a robot arm for a predetermined time; and
a processor configured to perform preprocessing on each of the acquired N input data sets through a probability distribution transformation model to derive N preprocessed data sets, and output output data composed of a translation value and a rotation value from a vision-robot coordinate transformation matrix generated using the N preprocessed data sets,
wherein the processor repeatedly performs the process of outputting the output data at least K times (K is an integer greater than N) to configure an output data set, and performs post-processing on the output data set through the probability distribution transformation model to output a single piece of post-processed data.
